(19) United States
(12) Patent Application Publication
(10) Pub. No.: US 2011/0114462 A1
(43) Pub. Date: May 19, 2011

(54) KEYSWITCH AND INPUT APPARATUS

(76) Inventors: Tsai-Jung Hu, Taoyuan (TW); Fang-Jung Lee, Taoyuan (TW)

(21) Appl. No.: 12/947,817

(22) Filed: Nov. 16, 2010

(30) Foreign Application Priority Data
Nov. 17, 2009 (TW) 098221350

(51) Int. Cl. H01H 13/705; H01H 13/14

(52) U.S. Cl. 200/5 A; 200/344

(57) ABSTRACT

The invention provides an input apparatus including a plurality of keyswitches. The keyswitch includes a keycap and a covering layer. The keycap includes an upper surface and a plurality of lateral surfaces. The plurality of lateral surfaces shows a first color related to the material of the keycap. The covering layer covers a first region of the top surface, so that the first region of the top surface shows a second color different from the first color.

### BACKGROUND OF THE INVENTION

1. Field of the Invention

The present invention relates to a keyswitch, and more particularly, to a keyswitch with different colors and a related input apparatus.

2. Description of the Prior Art

With the advanced technology, a computer is now in widespread use in family, factory, office, school, and so on. The computer, such as a desktop computer and a notebook computer, is a necessary tool and includes a conventional keyboard for inputting information conveniently.

However, a letter or a symbol is directly printed or formed on a keycap of each keyswitch of the conventional keyboard, which means the keyswitch of the conventional keyboard shows single color, such as a black color or a white color. In addition, aesthetic design of lateral surfaces of the keyswitch of the conventional keycap is neglected, so that the conventional keyboard with drab appearance can not attract consumers, and leads to low market competition.

### SUMMARY OF THE INVENTION

The present invention provides a keyswitch and a related input apparatus. The present invention selects the color of the keycap material and makes surface treatment on the upper surface of the keycap for showing two different colors on the keyswitch, so as to promote design aesthetic of the input apparatus and to increase market competition.

According to the claimed invention, the input apparatus of the present invention includes a plurality of keyswitches. Each keyswitch includes a keycap and a covering layer. The keycap includes an upper surface and a plurality of lateral surfaces. The plurality of lateral surfaces shows a first color related to material of the keycap. The covering layer covers a first region of the upper surface, so that the first region of the upper surface shows a second color different from the first color.

According to the claimed invention, the upper surface can further include a second region different from the first region. The second region can be located at an edge of the upper surface and shows the first color. The covering layer can be formed by the ink printing method, the heat transfer method, or the in-mold roller method. A specific region of the upper surface shows a specific color different from the second color, and a shape of the specific region corresponds to a specific character of the keyswitch. The specific region is formed on the upper surface by the ink printing method or the laser cutting method.

In the preferred embodiment, the material of the keycap can be the opaque material, the transparent material, or the fluorescent material. As the keycap is made of the opaque material, the first color of the plurality of lateral surfaces is the color of the opaque material. As the keycap is made of the transparent material, the first color of the plurality of lateral surfaces corresponds to the light emitted from the keyswitch. As the keycap is made of the fluorescent material, the first color of the plurality of lateral surfaces corresponds to the fluorescence emitted by the fluorescent material.

According to the claimed invention, the keyswitch of the present invention includes the keycap and the covering layer. The keycap includes the upper surface and the plurality of lateral surfaces. The plurality of lateral surfaces shows the first color related to the material of the keycap. The covering layer covers the first region of the upper surface, so that the first region of the upper surface shows the second color different from the first color.

According to the claimed invention, the upper surface can further include the second region different from the first region. The second region is located at the edge of the upper surface and shows the first color. The covering layer can be formed by the ink printing method, the heat transfer method, or the in-mold roller method. The specific region of the upper surface shows the specific color different from the second color, and the shape of the specific region corresponds to the specific character of the keyswitch. The specific region is formed on the upper surface by the ink printing method or the laser cutting method.

Comparing to the prior art, the keyswitch and the input apparatus of the present invention selects the color of the keycap material and makes surface treatment on the upper surface of the keycap, so that the keyswitch shows two different colors in appearance for promoting design aesthetic of the input apparatus. Therefore, the present invention can satisfy fashion demand of the consumer and increase market competition effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an input apparatus according to a preferred embodiment of the present invention.

FIG. 2 is a structural diagram of a keyswitch shown in FIG. 1.

FIG. 3 is a diagram of a keycap of the keyswitch shown in FIG. 2.

FIG. 4 is a diagram of the keycap of the keyswitch according to another preferred embodiment of the present invention.

FIG. 5A and FIG. 5B are diagrams of a specific region formed on an upper surface of the keycap according to another preferred embodiment of the present invention.

### DETAILED DESCRIPTION

According to an embodiment of the present invention, an input apparatus can be a keyboard or an electronic product with keyswitches, and it depends on actual demand.

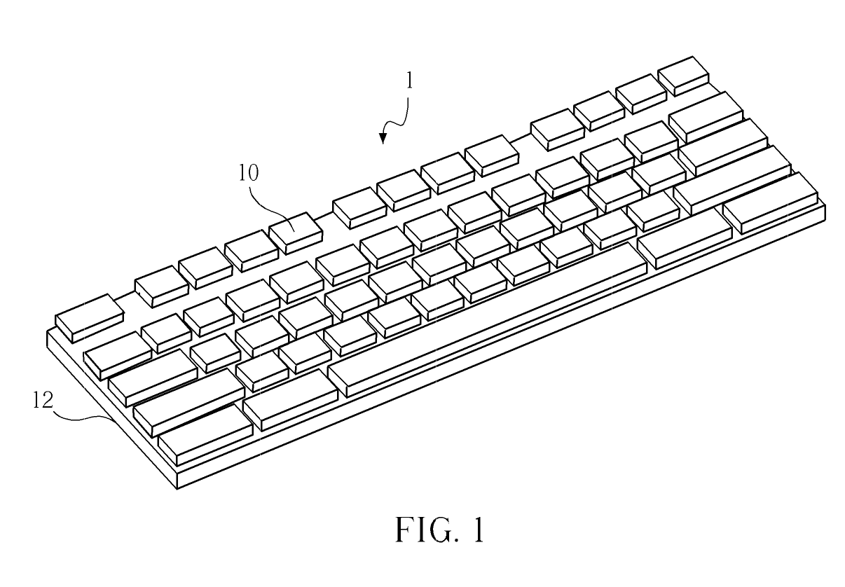

Please refer to FIG. 1, FIG. 1 is a schematic diagram of an input apparatus 1 according to a preferred embodiment of the present invention. As shown in FIG. 1, the input apparatus 1 can be a keyboard. The input apparatus 1 includes a base 12, and a plurality of keyswitches 10 disposed on the base 12. An amount and positions of the plurality of keyswitches 10 are not limited to the above-mentioned embodiment, and depend on actual demand.

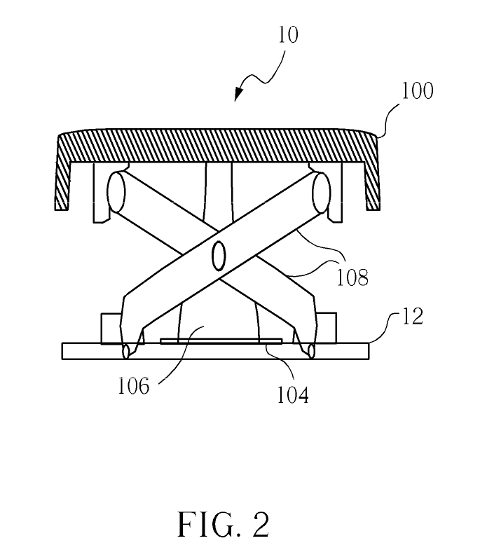

Please refer to FIG. 2, FIG. 2 is a structural diagram of the keyswitch 10 shown in FIG. 1. As shown in FIG. 2, the keyswitch 10 disposed on the base 12 includes a keycap 100, a flexible circuit board 104, a rubber cover 106, and a scissor-type member 108. It should be mentioned that the keyswitch 10 is not limited to the structure shown in FIG. 2, and it depends on design demand.

In this embodiment, the keycap 100 moves downward to deform the rubber cover 106 when the keyswitch 10 is pressed, so that a contacting portion disposed inside the rubber cover 106 contacts a switch disposed on the flexible circuit board 104, and then the switch can be actuated for transmitting a signal.

Generally, connection of the switch of the flexible circuit board 104 and the contacting portion of the rubber cover 106 can actuate an input or any other functions, such as entering a letter. The scissor-type member 108 is for driving the keycap 100 to an initial position where the keycap 100 has not been pressed when pressure on the keycap 100 is released. Operation of the keyswitch 10 of the input apparatus 1 is the same as operation of the conventional keyswitch, and the detailed description is omitted herein for simplicity.

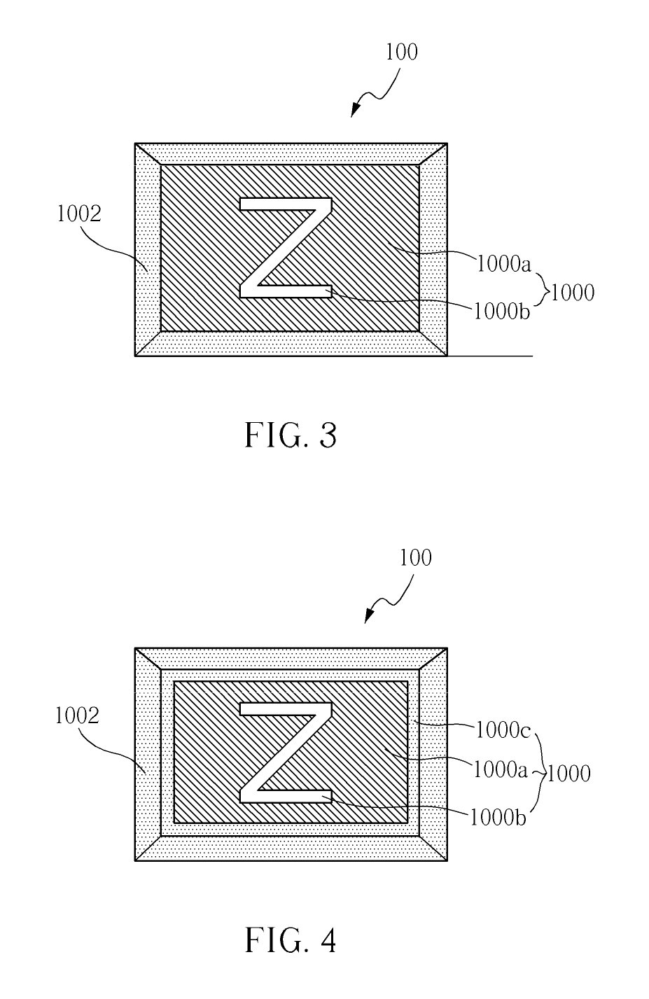

Please refer to FIG. 3, FIG. 3 is a diagram of the keycap 100 of the keyswitch 10 shown in FIG. 2. As shown in FIG. 3, The keycap 100 includes an upper surface 1000 and a plurality of lateral surfaces 1002, and the upper surface 1000 includes a first region 1000a and a specific region 1000b. It should be mentioned that an amount of the plurality of lateral surfaces 1002 of the keycap 100 corresponds to a shape of the keycap 100. For example, the keycap 100 can include three lateral surfaces or six lateral surfaces. The amount of the lateral surfaces 1002 is not limited to the keycap 100 with four lateral surfaces 1002 as shown in FIG. 3, and it depends on design demand.

In this embodiment, the lateral surfaces 1002 of the keycap 100 show a first color related to the material of the keycap 100. The dotted area shown in FIG. 3 represents the first color of the lateral surfaces 1002 of the keycap 100. That is to say, the four lateral surfaces 1002 of the keycap 100 show the original color of the material of the keycap 100, therefore, the first color is varied related to the material of the keycap 100. Generally, the material of the keycap 100 is selected according to structural strength demand of the keyswitch 10, and the first color of the lateral surfaces 1002 of the keycap 100 is related to the material of the keycap 10.

For example, as the keycap 100 is made of opaque material, the first color of the plurality of lateral surfaces 1002 of the keycap 100 is the color of the opaque material. As the keycap 100 is made of fluorescent material, the first color of the plurality of lateral surfaces 1002 of the keycap 100 corresponds to fluorescence emitted by the fluorescent material. In addition, as the keycap 100 is made of transparent material and light is emitted from the keyswitch 10, the light can pass through the transparent material of the keycap 100 and out of the keyswitch 10, which means the keyswitch 10 can be an illuminating keyswitch and the input apparatus 1 can be an illuminating keyboard. Thus, the first color of the plurality of lateral surfaces 1002 of the keycap 100 corresponds to the color of the light emitted from the keycap 100 of the keyswitch 10.

In this embodiment, the first region 1000a of the upper surface 1000 is covered by a covering layer, so that the first region 1000a of the upper surface 1000 shows a second color. A slash area shown in FIG. 3 represents the second color of the first region 1000a. Generally, the covering layer can be formed on the first region 1000a of the upper surface 1000 by an ink printing method, a heat transfer method, an in-mold roller method, or other methods, and it depends to actual demand. It should be mentioned that the second color of the first region 1000a of the upper surface 100 is different from the first color of the lateral surfaces 1002, and material of the covering layer has different color from the color of material of the keycap 100.

For example, as the material of the keycap 100 is white, which means the first color of the lateral surfaces 1002 of the keycap 100 is white, the covering layer with different color from the white color of the keycap 100 can be selected for forming on the first region 1000a of the upper surface 1000 by the ink printing method. For instance, the color of the covering layer can be black, yellow, blue, or so on.

As shown in FIG. 3, the specific region 1000b of the upper surface 1000 of the keycap 100 shows a specific color different from the second color, and a shape of the specific region 1000b corresponds to a specific character of the keyswitch 10. Generally, the specific character can be a letter, a numeral, a symbol, or a pattern. For example, the specific character of the keycap 100 as shown in FIG. 3 is “Z”. Selection of the specific character is not limited to the above-mentioned embodiment, and it depends on design demand. It should be mentioned that the specific color of the specific region 1000b is different from the second color of the first region 1000a for clearly distinguishing the specific character of the specific region 1000b from the first region 1000a.

Because the specific region 1000b is not adjacent to the lateral surfaces 1002, the specific color of the specific region 1000b can be the same as the first color of the lateral surfaces 1002. However, the specific color of the specific region 1000b can be different from the first color, and it depends on actual demand.

Please refer to FIG. 4, FIG. 4 is a diagram of the keycap 100 of the keyswitch 10 according to another preferred embodiment of the present invention. The upper surface 1000 of the keycap 100 shown in FIG. 4 not only includes the first region 1000a and the specific region 1000b shown in FIG. 3, but further includes a second region 1000c. In detail, the second region 1000c can be located at an edge of the upper surface 1000 and show the first color, which means the color of the second region 1000c can be the same as the color of the lateral surfaces 1002, so that the color of the first region 1000a is different from the color of the second region 1000c, and the upper surface shows two colors in outward appearance. Selection of the color of the second region 1000c is not limited to the above-mentioned embodiment, and it depends on design demand.

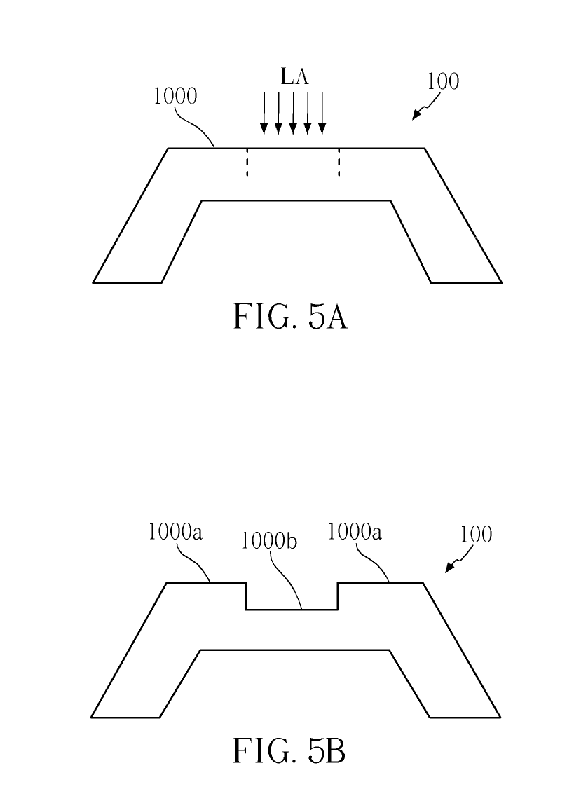

Generally, the specific region 1000b can be formed on the upper surface 1000 by the ink printing method or a laser cutting method. For example, the specific region 1000b can be directly formed on the first region 1000a of the upper surface 1000, or be formed on the covering layer covering on the first region 1000a. Please refer to FIG. 5A and FIG. 5B, FIG. 5A and FIG. 5B are diagrams of the specific region 1000b formed on the upper surface 1000 of the keycap 100 by the laser cutting method according to another preferred embodiment of the present invention.

As shown in FIG. 5A and FIG. 5B, the laser LA is emitted onto the upper surface 1000 of the keycap 100 for forming a sunken specific region 1000b on the upper surface 1000. Due to a height difference of the first region 1000a and the specific region 1000b, the keycap 100 can show the specific character, such as a “Z” pattern shown in FIG. 3.

As for another embodiment, a keyswitch is disclosed. The keyswitch of the present invention includes the keycap and the covering layer. The keycap includes the upper surface and the plurality of lateral surfaces. The plurality of lateral surfaces shows the first color related to the material of the keycap. The covering layer covers the first region of the upper surface, so that the first region of the upper surface shows the second color different from the first color.

In the preferred embodiment, the upper surface can further include the second region different from the first region. The second region is located at the edge of the upper surface and shows the first color. The covering layer can be formed by the ink printing method, the heat transfer method, or the in-mold roller method. The specific region of the upper surface shows the specific color different from the second color, and the shape of the specific region corresponds to the specific character of the keyswitch. The specific region is formed on the upper surface by the ink printing method or the laser cutting method.

In addition, the material of the keycap can be the opaque material, the transparent material, or the fluorescent material. As the keycap is made of the opaque material, the first color of the plurality of lateral surfaces is the color of the opaque material. As the keycap is made of the transparent material, the first color of the plurality of lateral surfaces corresponds to the light emitted from the keyswitch. As the keycap is made of the fluorescent material, the first color of the plurality of lateral surfaces corresponds to the fluorescence emitted by the fluorescent material.

Comparing to the prior art, the keyswitch and the input apparatus of the present invention selects the color of the keycap material and makes surface treatment on the upper surface of the keycap, so that the keyswitch shows two different colors in appearance for promoting design aesthetic of the input apparatus. Therefore, the present invention can satisfy fashion demand of the consumer and increase market competition effectively.

Those skilled in the art will readily observe that numerous modifications and alterations of the device and method may be made while retaining the teachings of the invention.

What is claimed is:

1. A keyswitch comprising:
a keycap comprising an upper surface and a plurality of lateral surfaces, the upper surface comprising a first region, the plurality of lateral surfaces showing a first color related to material of the keycap; and
a covering layer covering the first region of the upper surface for making the first region of the upper surface show a second color different from the first color.

2. The keyswitch of claim 1, wherein the covering layer is made by an ink printing method, a heat transfer method, or an in-mold roller (IMR) method.

3. The keyswitch of claim 1, wherein the upper surface further comprises a second region different from the first region, and the second region shows the first color.

4. The keyswitch of claim 3, wherein the second region is located at an edge of the upper surface.

5. The keyswitch of claim 1, wherein the upper surface further comprises a specific region showing a specific color different from the second color, and a form of the specific region corresponds to a specific character of the keyswitch.

6. The keyswitch of claim 5, wherein the specific form is a letter, a numeral, a symbol, or a pattern.

7. The keyswitch of claim 5, wherein the specific region is formed on the upper surface by an ink printing method or a laser cutting method.

8. The keyswitch of claim 1, wherein the keycap is made of opaque material, and the first color of the plurality of lateral surfaces is color of the opaque material.

9. The keyswitch of claim 1, wherein the keycap is made of transparent material, and the first color of the plurality of lateral surfaces corresponds to light emitted from the keycap.

10. The keyswitch of claim 1, wherein the keycap is made of fluorescent material, and the first color of the plurality of lateral surfaces corresponds to fluorescence emitted by the fluorescent material.

11. An input apparatus comprising:
a plurality of keyswitches, each keyswitch comprising:
a keycap comprising an upper surface and a plurality of lateral surfaces, the upper surface comprising a first region, the plurality of lateral surfaces showing a first color related to material of the keycap; and
a covering layer covering the first region of the upper surface for making the first region of the upper surface show a second color different from the first color.

12. The input apparatus of claim 11, wherein the covering layer is made by an ink printing method, a heat transfer method, or an in-mold roller (IMR) method.

13. The input apparatus of claim 11, wherein the upper surface further comprises a second region different from the first region, and the second region shows the first color.

14. The input apparatus of claim 13, wherein the second region is located at an edge of the upper surface.

15. The input apparatus of claim 11, wherein the upper surface further comprises a specific region showing a specific color different from the second color, and a form of the specific region corresponds to a specific character of the keyswitch.

16. The input apparatus of claim 15, wherein the specific character is a letter, a numeral, a symbol, or a pattern.

17. The input apparatus of claim 15, wherein the specific region is formed on the upper surface by an ink printing method or a laser cutting method.

18. The input apparatus of claim 11, wherein the keycap is made of opaque material, and the first color of the plurality of lateral surfaces is color of the opaque material.

19. The input apparatus of claim 11, wherein the keycap is made of transparent material, and the first color of the plurality of lateral surfaces corresponds to light emitted from the keycap.

20. The input apparatus of claim 11, wherein the keycap is made of fluorescent material, and the first color of the plurality of lateral surfaces corresponds to fluorescence emitted by the fluorescent material.
